(19) United States
(12) Patent Application Publication
(10) Pub. No.: US 2020/0073555 A1
(43) Pub. Date: Mar. 5, 2020

(54) STORAGE DEVICE AND CONTROL METHOD

(71) Applicant: Toshiba Memory Corporation, Tokyo (JP)

(72) Inventor: Hiroaki IIJIMA, Yokohama Kanagawa (JP)

(21) Appl. No.: 16/291,324

(22) Filed: Mar. 4, 2019

(30) Foreign Application Priority Data
Aug. 31, 2018 (JP) 2018-163399

(51) Int. Cl. G06F 3/06

(52) U.S. Cl. CPC G06F 3/0611; G06F 3/0688; G06F 3/0659

(57) ABSTRACT

A storage device includes a plurality of non-volatile memory devices and a controller connected to the plurality of non-volatile memory devices. The controller is configured to enable the plurality of non-volatile memory devices simultaneously during a certain period of time, and broadcast an access command and an access destination address to the plurality of non-volatile memory devices during the certain period of time.

### CROSS-REFERENCE TO RELATED APPLICATION

This application is based upon and claims the benefit of priority from Japanese Patent Application No. 2018-163399, filed on Aug. 31, 2018, the entire contents of which are incorporated herein by reference.

### FIELD

Embodiments described herein relate generally to a storage device and a control method.

### BACKGROUND

In a storage device such as a solid state drive (SSD), for example, an access such as reading or writing of data is performed with respect to a memory device from a memory access circuit via various signal lines. The memory access circuit has a structure that adjusts a delay of signals so that communication of reading data or writing data can be reliably carried out between the memory access circuit and the memory device. As the memory device, a flash memory having a planar NAND memory cell, a flash memory having a three-dimensional memory cell, and the like are used.

### DESCRIPTION OF THE DRAWINGS

FIG. 1 is a block diagram showing an example of a configuration of a storage device according to an embodiment.

FIG. 2 is a block diagram showing an example of a configuration of a memory access circuit of the storage device according to the embodiment.

FIG. 3 is a diagram illustrating a relationship between data signals and a strobe signal in the storage device according to the embodiment.

FIG. 4 is a timing chart showing a comparative example of a memory access to a NAND device.

FIG. 5 is a timing chart showing an example of a command phase and a write phase in the storage device according to the embodiment.

FIG. 6 is a timing chart showing a first example of a read phase in the storage device according to the embodiment.

FIG. 7 is a timing chart showing a second example of the read phase in the storage device according to the embodiment.

FIG. 8 is a flowchart showing an example of a read training procedure of the storage device according to the embodiment.

FIG. 9 is a flowchart showing an example of a write training procedure of the storage device according to the embodiment.

### DETAILED DESCRIPTION

Embodiments provide a storage device and a control method that shorten a time required for a read access or a write access.

In general, according to an embodiment, a storage device includes a plurality of non-volatile memory devices and a controller connected to the plurality of non-volatile memory devices. The controller is configured to enable the plurality of non-volatile memory devices simultaneously during a certain period of time, and broadcast a write command and a write destination address to the plurality of non-volatile memory devices during the certain period of time.

According to another embodiment, a storage device includes a plurality of non-volatile memory devices and a controller connected to the plurality of non-volatile memory devices. The controller is configured to enable the plurality of non-volatile memory devices simultaneously during a certain period of time, and broadcast a read command and a read destination address to the plurality of non-volatile memory devices during the certain period of time.

Generally, in a delay adjustment circuit of the related art, delay adjustment of signals is performed using an adjustment value of a delay amount preset for the signals. In order to determine the adjustment value, a read access or a write access from a memory access circuit to a memory device is repeatedly performed. Then, an adjustment value corresponding to an optimum delay amount capable of correctly reading or writing data is calculated. Hereinafter, calculation of the adjustment value is referred to as training.

In the training, a parallel type memory access circuit having a data bus of a plurality of bit widths individually repeats a read access or a write access to the NAND device, and acquires distributions of a delay amount for which reading or writing of data is passed and a delay amount for which reading or writing of data is failed for each bit of the data bus.

In addition, in the training, for example, when a plurality of NAND devices are connected per channel of the memory access circuit, it is necessary to repeatedly acquire the above distribution for all the NAND devices. That is, the number of times of accesses to the NAND device increases in proportion to the number of connected NAND devices. Therefore, a time required to complete the training largely depends on an access time to the NAND device.

Generally, when the memory access circuit accesses the NAND device, a command phase takes time, so a time during which data is not read or written is relatively long. This is one of the reasons that a random access performance to the NAND device is low.

In the storage device according to the embodiment, even when the number of NAND devices connected per channel of the memory access circuit is large, it is made accessible to the plurality of NAND devices at one time. Accordingly, a time required for the read access or the write access to the NAND device is shortened, and furthermore, training of the memory access circuit can be completed in a short time.

Hereinafter, the embodiment will be described with reference to the drawings. In the following description, substantially or essentially the same functions and components are denoted by the same reference numerals, and descriptions thereof will be made as necessary.

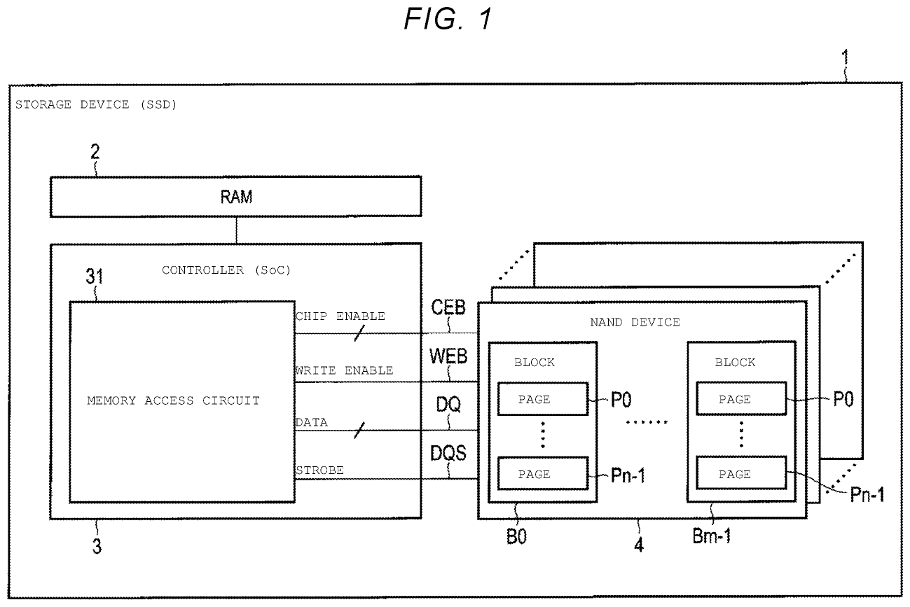

FIG. 1 is a block diagram showing an example of a configuration of a storage device 1 according to the embodiment.

The storage device 1 is a storage device such as a solid state drive (SSD), for example. The storage device 1 includes a random access memory (RAM) 2, a controller 3, a NAND device 4, and the like. The RAM 2 and the NAND device are electrically connected to the controller 3. A plurality of the NAND devices 4 are connected to the controller 3.

The RAM 2 is used as a work area of the controller 3. The RAM 2 may be used, for example, as cache memory for temporarily storing data. The RAM 2 is volatile memory such as static random access memory (SRAM) or dynamic random access memory (DRAM).

The controller 3 is, for example, an integrated circuit (IC) that controls the operation of the entire storage device 1, and is configured with, for example, a system on chip (SoC). The controller 3 includes a memory access circuit 31.

The memory access circuit 31 performs a memory access such as a read access and a write access to the NAND device 4.

The memory access circuit 31 and the NAND device 4 are connected by an address bus designating an address for the memory access, a data bus for communicating read data or write data, a control bus for transmitting and receiving control signals, and the like. In the following description, the description of the address bus will be omitted.

The control bus includes, for example, a chip enable signal CEB designating a chip in the NAND device 4 selected as an access target, a write enable signal WEB indicating the command and address fetch timing, a strobe signal (also referred to as a clock signal) DQS indicating a timing of acquiring data with respect to a data signal DQ, and the like.

Each of the above signals may be represented by another name. For example, the chip enable signal CEB may be a signal represented by another name, which has a similar function, such as a chip select signal or a device select signal.

Although the chip enable signal CEB is assumed to be switched on or off for each NAND device 4, the plurality of NAND devices 4 may be allocated to one chip enable signal CEB and the ON or OFF of the NAND device 4 that is the access target may be switched by command control.

The data bus includes, for example, a data signal DQ for transmitting write data or receiving read data.

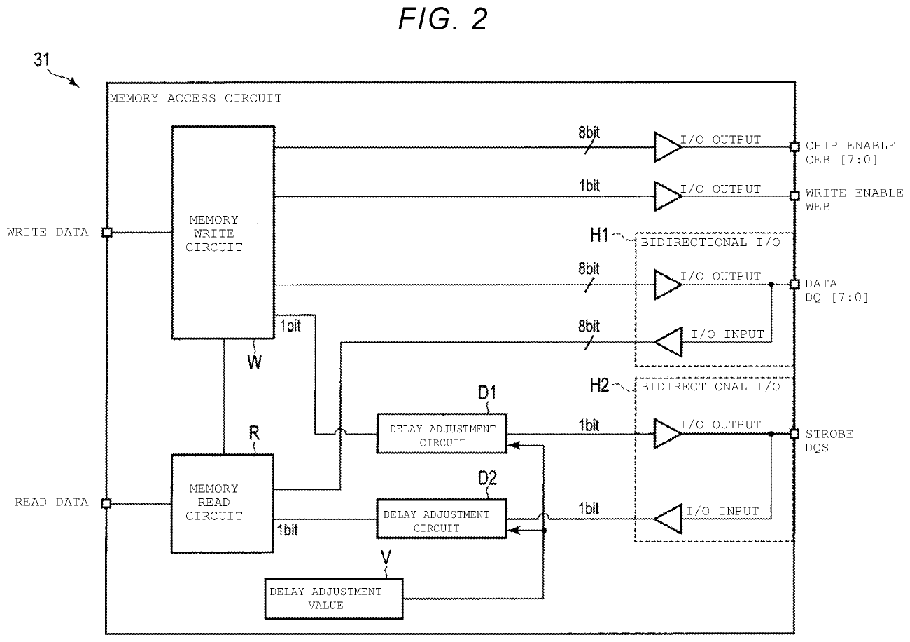

The data signal DQ and the strobe signal DQS are signals that can be bidirectionally communicated. Signals other than those described above may be transmitted or received using the data bus and the control bus. Details of the memory access circuit 31 will be described below with reference to FIG. 2.

In addition to the memory access circuit 31, the controller 3 may include, for example, an interface (I/F) with a host device connectable to the storage device 1, a central processing unit (CPU), and a controller of the RAM 2. Further, the controller 3 may include a storage area such as a RAM or a ROM.

The NAND device 4 is non-volatile memory configuring a storage area of the storage device 1. The NAND device 4 is, for example, a NAND flash memory, but may be other non-volatile semiconductor memory such as NOR flash memory, magnetoresistive random access memory (MRAM: magnetoresistive memory), phasechange random access memory (PRAM: phase change memory), resistive random access memory (ReRAM: resistance change type memory), ferroelectric random access memory (FeRAM), or magnetic memory. For example, the NAND device 4 may be memory having a planar arrangement structure of storage elements, or memory having a three-dimensional arrangement structure of storage elements.

The NAND device 4 includes at least one NAND flash memory chip (a plurality of NAND flash memory dies).

Each chip includes a memory cell array. The memory cell array includes a plurality of NAND blocks (blocks) B0 to Bm-1 (m is an integer of 1 or more). The blocks B0 to Bm-1 function as erase units. The block may also be referred to as a “physical block” or an “erase block”.

The blocks B0 to Bm-1 include a plurality of pages (physical pages). That is, each of the blocks B0 to Bm-1 includes pages P0 to Pn-1 (n is an integer of 2 or more). In the non-volatile memory, reading of data and writing of data are executed in page units, and erasing of data is executed in block units.

FIG. 2 is a block diagram showing an example of a configuration of the memory access circuit 31 of the storage device 1 according to the embodiment.

The memory access circuit 31 includes a memory write circuit W, a memory read circuit R, delay adjustment circuits D1 and D2, circuits for storing bidirectional I/Os H1 and H2 and a delay adjustment value V, and the like.

The bidirectional I/Os H1 and H2 are, for example, circuits for switching a communication direction of the signal according to whether the memory access to the NAND device 4 is either a write access or a read access.

Hereinafter, the operation of the memory access circuit when data is written from the memory access circuit 31 to the NAND device 4 will be described.

The controller 3 receives a write command, a logical address of a write destination, write data, and the like from, for example, the host device or the like connected to the storage device 1.

The controller 3 converts the logical address of the write destination into a physical address. The physical address is output from the memory access circuit 31 to the NAND device 4 via the address bus.

The write data passes through the memory write circuit W and is output to the NAND device 4 as the data signal DQ via the bidirectional I/O H1. In the embodiment, it is assumed that the data signal DQ is, for example, an 8-bit parallel signal (DQ0 to DQ7).

The memory write circuit W generates a write strobe signal. The delay of the write strobe signal is adjusted by the delay adjustment circuit D1. The adjusted write strobe signal is output to the NAND device 4 as the strobe signal DQS via the bidirectional I/O H2.

In addition, the memory write circuit W generates the write enable signal WEB and the chip enable signal CEB indicating the NAND device 4 as the access target. The generated write enable signal WEB and the generated chip enable signal CEB are output to each NAND device 4.

In the embodiment, it is described that the eight NAND devices 4 are connected to the memory access circuit 31, and the chip enable signal is an 8-bit signal (CEB0 to CEB7).

Hereinafter, the operation of the memory access circuit 31 when data is read from the NAND device 4 to the memory access circuit 31 will be described.

The controller 3 receives a read command, a logical address of a read destination, and the like from, for example, the host device or the like connected to the storage device 1.

The controller 3 converts the logical address of the read destination into a physical address. The physical address is output from the memory access circuit 31 to the NAND device 4 via the address bus.

The memory read circuit R generates a chip enable signal CEB indicating the NAND device 4 of the read destination and outputs the chip enable signal CEB to the NAND device 4 via the memory write circuit W.

The NAND device 4 transmits the read data based on the address to the memory access circuit 31. The read data is input to the memory access circuit 31 as the data signal DQ via the bidirectional I/O H1 and is transmitted to the host device or the like connected to, for example, the storage device 1 via the memory read circuit R.

In addition, the memory read circuit R outputs a read enable (REB) signal (not shown) to the NAND device 4. The read enable signal is used as a signal (clock signal) indicating transmission of a read transfer period and the timing of acquiring the read data.

In addition, when the read enable signal is received, the NAND device 4 outputs a read strobe signal together with the read data to the memory access circuit 31. The read strobe signal is input to the memory access circuit 31 via the bidirectional I/O H2 (as the strobe signal DQS), and the delay of the read strobe signal is adjusted by the delay adjustment circuit D2. The adjusted read strobe signal is input to the memory read circuit R.

The delay adjustment circuits D1 and D2 adjust the timing of signals based on the delay adjustment value V. The delay adjustment circuit D1 is a delay adjustment circuit for transmission and the delay adjustment circuit D2 is a delay adjustment circuit for reception. It is preferable that the delay adjustment value V is held for each NAND device 4. That is, the delay adjustment value V may be changed each time the NAND device 4 that is the access target is switched.

The delay adjustment value V may be held in the memory access circuit 31 or may be stored in the storage area in the controller 3.

In the embodiment, it is described that the delay adjustment circuits D1 and D2 are connected with respect to the strobe signal DQS output or input from the memory access circuit 31; however, delay adjustment may be performed by connecting a similar delay adjustment circuit also with respect to other signals (such as the chip enable signal CEB, the write enable signal WEB, and the data signal DQ).

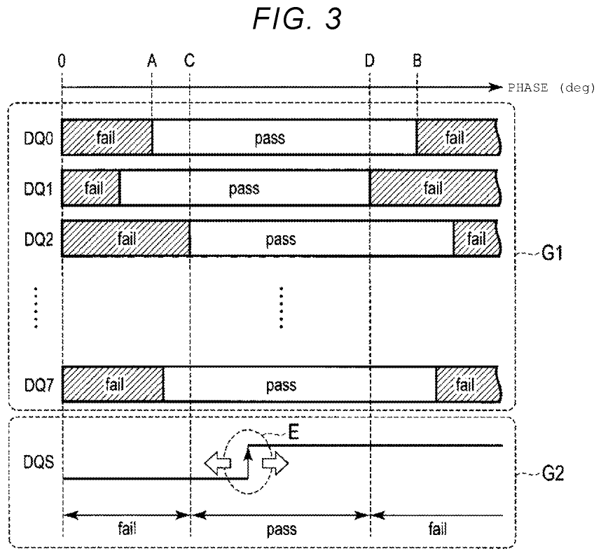

FIG. 3 is a diagram illustrating a relationship between the data signal DQ and the strobe signal DQS in the storage device according to the embodiment.

As described above, when the read access or the write access is performed to the NAND device 4, the data of the data signal DQ is acquired at the timing based on the strobe signal DQS (for example, rising edge or falling edge of the strobe signal DQS).

However, when the timing of acquiring the data generated based on the strobe signal DQS and the timing at which the data is stably present in the data signal DQ are shifted, acquisition of the data may fail. Therefore, by the above-described training, an adjustment value indicating the optimum delay amount of the strobe signal DQS is calculated, and the delay of the strobe signal is adjusted by the adjustment value.

In the training, the delay amount of the strobe signal DQS is changed by a predetermined value, whether or not acquisition of data signal DQ0 is passed is checked, and a value which is a boundary of the pass or fail is obtained.

A graph G1 is a graph illustrating distributions of whether or not data can be correctly acquired according to a change in the delay amount of the strobe signal DQS for each of the data signals DQ0 to DQ7. A horizontal axis of the graph G1 indicates the delay amount (phase: unit [deg]) of the strobe signal DQS.

For example, with respect to the data signal DQ0, the horizontal axis of the graph G1 indicates that when the phase of the strobe signal DQS is delayed by an amount in a range from 0 to A [deg], acquisition of the data signal DQ0 is failed, when the phase of the strobe signal DQS is delayed by an amount in a range from A to B [deg], the acquisition of the data signal DQ0 is passed, and when the delay amount is further increased and the phase of the strobe signal DQS is delayed by an amount of B [deg] or more, the acquisition of the data signal DQ0 is failed.

By the above procedure, the same distributions are obtained for the other data signals DQ1 to DQ7.

A graph G2 is a graph showing the optimum delay amount of the strobe signal DQS. It is preferable that a delay amount of an edge E of the strobe signal DQS is adjusted so that all the data signals DQ0 to DQ7 can be acquired. In the example of the distributions of the data signals DQ0 to DQ7 shown in the graph G1, it can be seen that the delay amount of the strobe signal DQS for which the acquisition of all the data signals DQ0 to DQ7 is passed is from C to D [deg]. Therefore, the adjustment value indicating the optimum delay amount of the strobe signal DQS is C to D [deg].

In order to obtain the adjustment value of the strobe signal DQS as described above, it is necessary to repeatedly perform the read access or the write access. Therefore, the shorter the time required for the read access or the write access, the more efficient training can be performed.

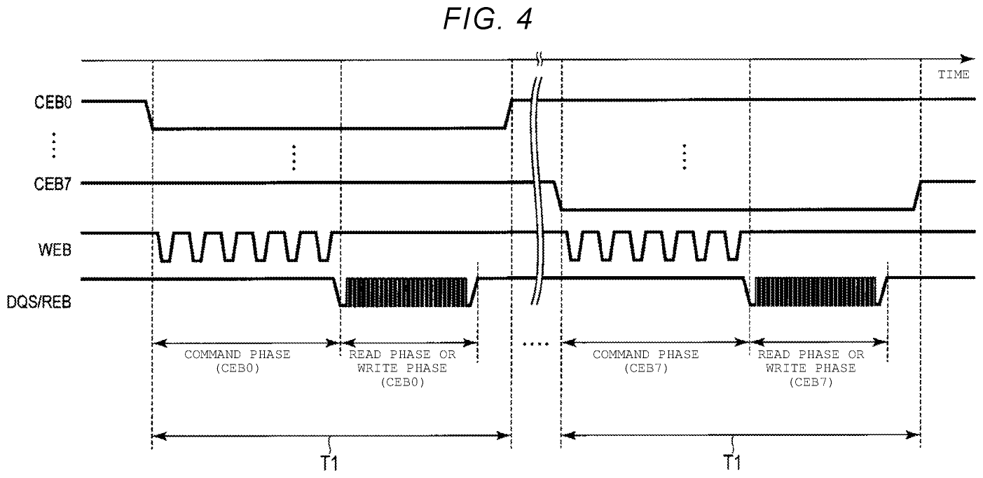

FIG. 4 is a timing chart showing an example of a memory access to a NAND device according to a comparative example. More specifically, FIG. 4 shows a timing chart of signals included in a command bus when the read access or the write access is sequentially performed for eight NAND devices.

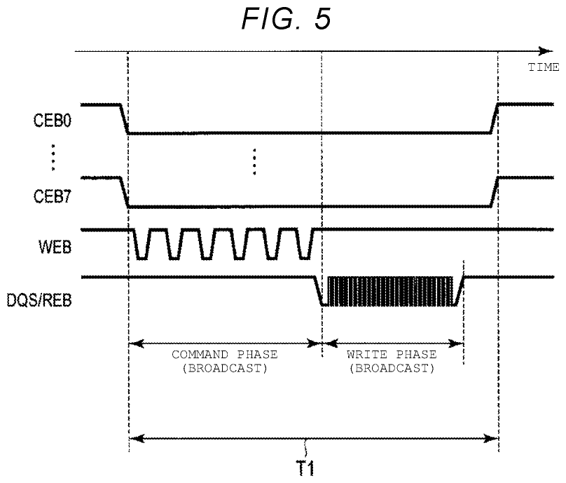

In FIG. 4, a timing chart of signals included in the data bus and the address bus is omitted. Hereinafter, the same applies to FIGS. 5 to 7.

First, a memory access circuit sets a chip enable signal CEB0 to an active state (L level) in order to start an access to a first NAND device. Then, the memory access circuit starts a command phase to the first NAND device. The command phase includes transmission of a control command such as a read command or a write command, and transmission of an address of an access destination (that is, a read destination or a write destination), and the like. For example, according to a rise of the write enable signal WEB, the command and the address are fetched into the NAND device.

After the command phase is completed, the memory access circuit starts a read phase or a write phase to the first NAND device. In the read phase or the write phase, communication of read data or write data is performed between the memory access circuit and the NAND device.

After the read phase or the write phase is completed, the chip enable signal CEB0 is set to an inactive state (H level). Then, the memory access circuit sets a chip enable signal CEB1 to the active state in order to start an access to the next (second) NAND device. Thereafter, chip enable signals CEB2 to CEB7 are sequentially switched in the same manner.

Here, assuming that an access time to one NAND device (that is, a time during which chip enable is made active for one NAND device) is time T1, time of (8 ×time T1) is required to complete the access to all the NAND devices.

Hereinafter, a method and a process of shortening a time of the read access or the write access will be described with reference to FIGS. 5 to 7.

FIG. 5 is a timing chart showing an example of a command phase and a write phase in the storage device 1 according to the embodiment.

In the training described above, for example, the same data is often written to all the NAND devices 4 in order to clarify characteristic differences between the NAND devices 4. That is, in the write access in the training, a set value and data included in the command phase and the write phase for each NAND device 4 are the same.

Therefore, the memory access circuit 31 can shorten a time required for the write access by performing the write access to the NAND device 4 as described below.

First, the memory access circuit 31 sets the eight chip enable signals CEB0 to CEB7 to an active state in order to start an access to all the NAND devices 4.

Then, the memory access circuit 31 starts a command phase. In the command phase, control commands such as the same write command, addresses of the same write destination, and the like are transmitted (in other words, broadcasted) to all the NAND devices 4.

After the command phase is completed, the memory access circuit 31 starts a write phase. In the write phase of FIG. 5, the same write data is transmitted (broadcasted) to all the NAND devices 4.

Each NAND device 4 writes the received write data to the received address. Accordingly, the memory access circuit 31 can complete the write access to the plurality of (in this example, eight) NAND devices 4 at time T1, for example.

The write access shown in FIG. 5 may be applied to other than the training. For example, the write access may also be applied when writing the same data to the plurality of NAND devices 4.

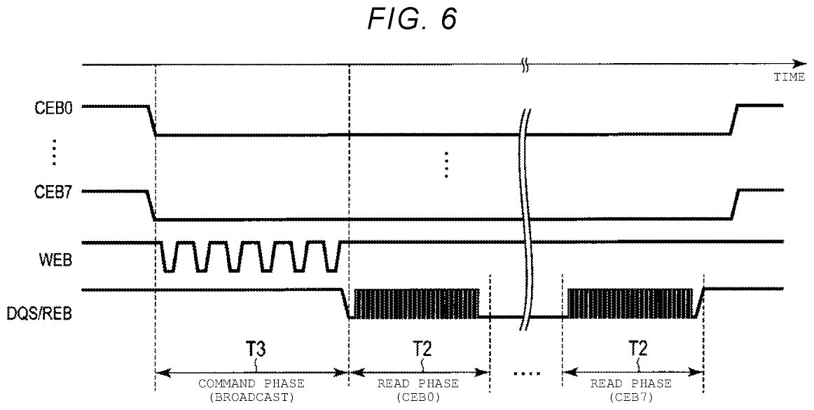

FIG. 6 is a timing chart showing a first example of a read phase in the storage device 1 according to the embodiment.

In the training, it is checked that the written data can be correctly read. For example, when the same data is written to each NAND device 4 as shown in FIG. 5, the set values included in the command phase for reading these data are the same for all the NAND devices 4. Therefore, the memory access circuit 31 can shorten a time required for the read access by performing the read access to the NAND device 4 as described below.

First, the memory access circuit 31 sets the eight chip enable signals CEB0 to CEB7 to an active state in order to start an access to all the NAND devices 4 provided in the NAND device 4.

The memory access circuit 31 starts a command phase. In the command phase, control commands such as the same read command, addresses of the read destination, and the like are transmitted (in other words, broadcasted) to all the NAND devices 4.

Thereafter, the memory access circuit 31 starts the read phases of the respective NAND devices 4 according to a predetermined order (hereinafter referred to as a read order), and receives read data from each NAND device 4. Each NAND device 4 sequentially transmits the read data to the memory access circuit 31 according to the read order.

It is preferable that the number of data read in the read phase (hereinafter referred to as the number of data N) is fixed and the number of data N is shared in advance by the memory access circuit 31 and the NAND device 4. Instead of the number of data, for example, the number of clocks necessary for the read phase and the like may be shared.

For example, the memory access circuit 31 starts the read phase of the NAND device 4 having the first read order (referred to as a device A) after completion of the command phase. The NAND device A transmits the read data to the memory access circuit 31 after the completion of the command phase. The length of the read phase is a time (referred to as time T2) required for transmission of N pieces of read data.

Further, for example, the memory access circuit 31 starts the read phase of the NAND device 4 having the eighth read order (referred to as a device B) after the completion of the command phase (7 × time T2). The device B counts a time required to transmit the 7 ×N pieces of read data transmitted by the NAND devices 4 having the first to seventh read order after the completion of the command phase, that is, a lapse of a time of (7 ×time T2) and transmits the read data to the memory access circuit 31 after the lapse of the time.

That is, any NAND device 4 of the plurality of NAND devices 4 determines a timing of transmitting read data from the NAND device 4 based on the number of read data (that is, the length of read data) to be transmitted to the memory access circuit 31 before the read data is transmitted to the NAND device 4.

Accordingly, the memory access circuit 31 can complete the read access to all the NAND devices 4, for example, at a time required for one command phase (time T3) and a time required for the read phase of each NAND device 4 (8 ×time T2).

Each time the command is received, the NAND device 4 may calculate the length (time T2) of the read phase per NAND device 4 from the length of the data specified in the command phase. Accordingly, each NAND device 4 can correctly transmit the read data to the memory access circuit 31 even when the length of the data specified in the command phase changes.

Further, the timing of transmitting the read data from each NAND device 4 may be determined for each NAND device 4, for example, by presetting.

The read access shown in FIG. 6 may be applied to other than the training. For example, the read access may also be applied when reading data of the same length stored in the same address of each NAND device 4.

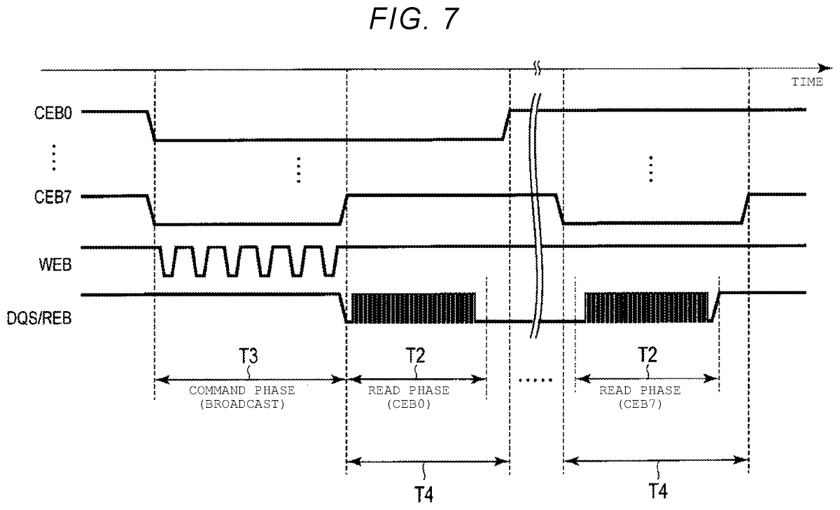

FIG. 7 is a timing chart showing a second example of the read phase in the storage device 1 according to the embodiment.

In the example of FIG. 6, the output read data timing of each NAND device 4 is determined and switched by sharing the number N of read data (the length of read data) with the memory access circuit 31 and the NAND device 4. In the second example of the read phase shown in FIG. 7, this switching is performed by using the chip enable signal CEB.

As in FIG. 6, the memory access circuit 31 sets the chip enable signals CEB0 to CEB7 of all the NAND devices 4 to the active state and starts the command phase.

Next, the memory access circuit 31 keeps only the chip enable signal CEB0 of the NAND device 4 (referred to as a device A) having the first read order in the active state and sets the chip enable signals of the other NAND devices 4 to the inactive state. The memory access circuit 31 starts the read phase of the device A, and the device A transmits the read data to the memory access circuit 31.

Thereafter, the memory access circuit 31 sequentially sets the chip enable signals of the respective NAND devices 4 to the active state according to the read order. Each NAND device 4 transmits the read data to the memory access circuit 31 at the timing when the chip enable signal CEB corresponding to each NAND device 4 becomes active.

For example, after the read phase of the device A is completed and the chip enable signal CEB0 enters the inactive state, the memory access circuit 31 sets the chip enable signal CEB1 of the NAND device 4 (referred to as a device C) having the second read order to the active state again. The device C starts transmitting the read data to the memory access circuit 31 at the timing when the chip enable signal CEB1 becomes active.

Accordingly, the memory access circuit 31 can complete the read access for the NAND device 4, for example, at a time (time T3) required for one command phase and a time (8 ×time T4) to set the chip enable signal CEB for the read phase of each NAND device 4 to the active state.

As in FIG. 6, the read access shown in FIG. 7 may be applied to other than the training.

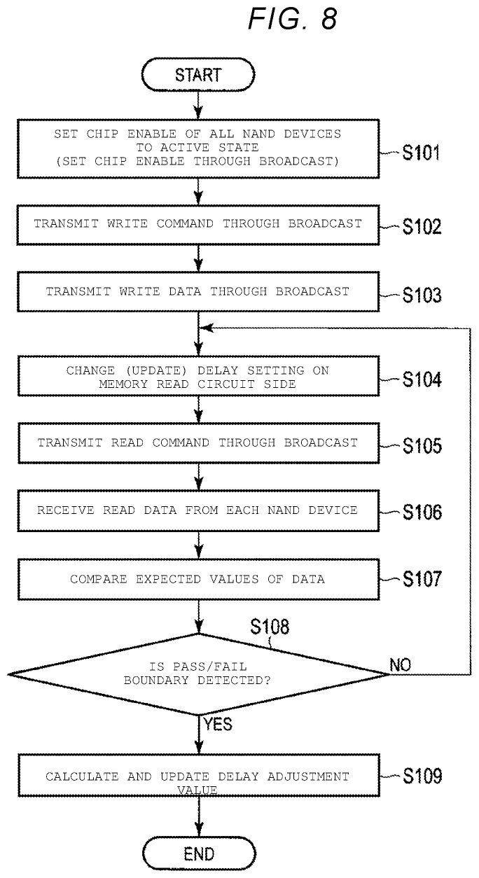

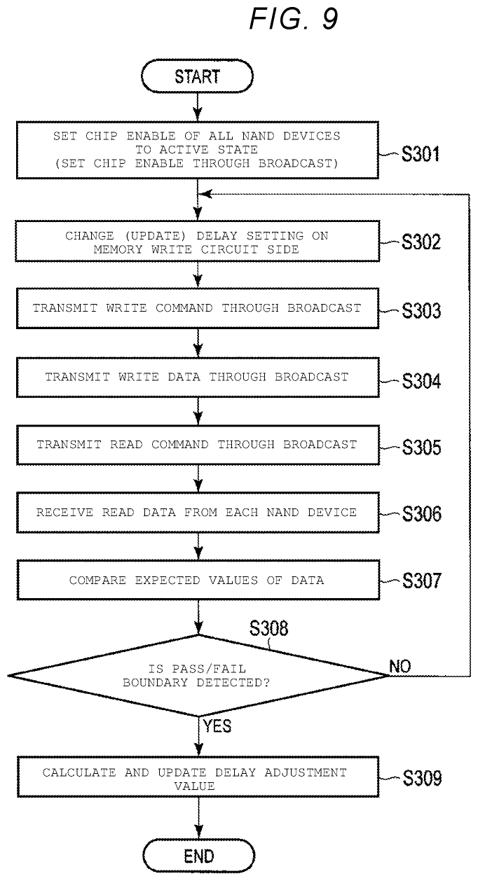

The training procedure will be described in detail below with reference to FIGS. 8 and 9.

FIG. 8 is a flowchart showing an example of read training of the storage device 1 according to the embodiment.

In S101, the memory access circuit 31 sets the chip enable signals CEB0 to CEB7 of all the NAND devices 4 to an active state. In other words, the memory access circuit 31 sets the chip enable signals CEB0 to CEB7 of all the NAND devices 4 to the active state through broadcast.

In S102, the memory access circuit 31 transmits a write command to each NAND device 4 through the broadcast.

In S103, the memory access circuit 31 transmits write data to each NAND device 4 through the broadcast.

In S104, the memory access circuit 31 changes (updates) the delay setting of the delay adjustment circuit D2 on the memory read circuit R side using the latest delay adjustment value V.

In S105, the memory access circuit 31 transmits a read command to each NAND device 4 through the broadcast.

In S106, the memory access circuit 31 receives read data from each NAND device 4.

In S107, the memory access circuit 31 compares the expected values of the data. More specifically, the memory access circuit 31 compares the received read data with the write data transmitted in S103, and determines whether the reading of the data is passed or failed.

In S108, the memory access circuit 31 determines the distribution as to whether or not the data can be correctly read according to the change in the delay setting as shown in FIG. 3, that is, whether or not the boundary between the pass and the fail of the reading is detected.

When the memory access circuit 31 determines that no boundary is detected (NO in S108), the process returns to S104. The memory access circuit 31 changes the adjustment value of the delay adjustment circuit D2 and executes the processes after S105.

Meanwhile, when the memory access circuit 31 determines that the boundary is detected (YES in S108), the process proceeds to S109. In S109, the memory access circuit 31 calculates an adjustment value indicating the optimum delay amount based on the boundary. Further, the memory access circuit 31 updates the delay setting of the delay adjustment circuit D2 based on the calculated adjustment value. By the above procedure, the read training is completed.

FIG. 9 is a flowchart showing an example of write training of the storage device 1 according to the embodiment.

Since the process in S301 is the same as the process in S101, the description thereof will be omitted.

In S302, the memory access circuit 31 updates the delay setting of the delay adjustment circuit D1 on the memory write circuit W side using the latest delay adjustment value V.

In S303 and S304, the memory access circuit 31 performs a write access to each NAND device 4. Since the processes in S303 and S304 are the same as the processes in S102 and S103, the description thereof will be omitted.

In S305 and S306, the memory access circuit 31 performs a read access to each NAND device 4. Since the processes in S305 and S306 are the same as the processes in S105 and S106, the description thereof will be omitted.

In S307, the memory access circuit 31 compares the data expected values. More specifically, the memory access circuit 31 compares the received read data with the write data transmitted in S304, and determines whether the writing of the data is passed or failed.

In S308, the memory access circuit 31 determines the distribution as to whether or not the data can be correctly written according to the change in the delay setting as shown in FIG. 3, that is, whether or not the boundary between the pass and the fail of the writing is detected.

When the memory access circuit 31 determines that no boundary is detected (NO in S308), the process returns to S302. The memory access circuit 31 changes the adjustment value of the delay adjustment circuit D1 and repeats the same process.

Meanwhile, when the memory access circuit 31 determines that the boundary is detected (YES in S308), the process proceeds to S309. In S309, the memory access circuit 31 calculates an adjustment value indicating the optimum delay amount based on the boundary. Further, the memory access circuit 31 updates the delay setting of the delay adjustment circuit D1 based on the adjustment value. By the above procedure, the write training is completed.

In the embodiment described above, the memory access circuit 31 broadcasts the command phase and the write phase when performing the write access to the NAND device 4. Accordingly, even when the number of NAND devices 4 connected to the controller 3 is large, the write access to the NAND device 4 can be performed in parallel, thereby a time required to complete the write access can be shortened.

In the embodiment, when performing the read access to the NAND device 4, the memory access circuit 31 first broadcasts the command phase and thereafter switches the read phase for each NAND device. Each NAND device switches the NAND device as a transmission source of the read data each time a predetermined time is elapsed so that the read data can be transmitted to the memory access circuit 31 in the read phase corresponding to each NAND device.

Accordingly, the memory access circuit 31 can receive the read data from all the NAND devices 4 in one command phase at the time of the read access, so that the time required for the read access to the NAND device 4 can be shortened.

When performing the read access to the NAND device 4, the memory access circuit 31 first broadcasts the command phase, thereafter switches the chip enable signal CEB for each NAND device, and starts the read phase of the NAND device 4 corresponding to the chip enable signal CEB. Each NAND device transmits the read data to the memory access circuit 31 during a period in which the chip enable signal CEB corresponding to each NAND device is in the active state.

Accordingly, similarly, the memory access circuit 31 can receive the read data from all the NAND devices 4 in one command phase at the time of the read access, so that the time required for the read access to the NAND device 4 can be shortened.

The reduction in the time required for the write access or the read access is particularly useful in training and can also be applied to ordinary write access and read access other than training.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A storage device comprising:
a plurality of non-volatile memory devices; and
a controller connected to the plurality of non-volatile memory devices and configured to enable the plurality of non-volatile memory devices simultaneously during a certain period of time, and broadcast a write command and a write destination address to the plurality of non-volatile memory devices during the certain period of time.

2. The storage device according to claim 1, wherein the controller is further configured to broadcast write data corresponding to the write command to the plurality of non-volatile memory devices during the certain period of time, after broadcasting the write command and the write destination address.

3. The storage device according to claim 1, wherein
the controller includes a delay adjustment circuit configured to adjust a delay amount of a signal transmitted from the controller to the plurality of non-volatile memory devices, and
the controller broadcasts the write command during a process to determine the delay amount.

4. The storage device according to claim 1, wherein the controller is further configured to enable the plurality of non-volatile memory devices simultaneously during a second certain period of time, and broadcast a read command and a read destination address to the plurality of non-volatile memory devices during the second certain period of time.

5. The storage device according to claim 4, wherein the controller is further configured to:
enable only a first one of the plurality of non-volatile memory devices during a third certain period of time after the second certain period of time and receive read data corresponding to the read command from the first one of the plurality of non-volatile memory devices during the third certain period of time; and
enable only a second one of the plurality of non-volatile memory devices during a fourth certain period of time after the third certain period of time and receive read data corresponding to the read command from the second one of the plurality of non-volatile memory devices during the fourth certain period of time.

6. The storage device according to claim 4, wherein
a first one of the plurality of non-volatile memory devices is configured to transmit read data corresponding to the read command to the controller a first predetermined period of time after receiving the read command, and
a second one of the plurality of non-volatile memory devices is configured to transmit read data corresponding to the read command to the controller a second predetermined period of time after receiving the read command, the second predetermined period of time being different from the first predetermined period of time.

7. The storage device according to claim 6, wherein
a time period during which the read data from the first one of the plurality of non-volatile memory devices is transmitted to the controller has no overlap with a time period during which the read data from the second one of the plurality of non-volatile memory devices is transmitted to the controller.

8. The storage device according to claim 6, wherein
a first chip enable signal line is connected between the controller and the first one of the plurality of non-volatile memory devices,
a second chip enable signal line is connected between the controller and the second one of the plurality of non-volatile memory devices, and
the controller is configured to assert a first chip enable signal via the first chip enable signal line to enable the first one of the plurality of non-volatile memory devices, and also to assert a second chip enable signal via the second chip enable signal line to enable the second one of the plurality of non-volatile memory devices, during the first predetermined period of time and the second predetermined period of time. (This claim corresponds to FIG. 6.)

9. The storage device according to claim 4, wherein
the controller includes a delay adjustment circuit configured to adjust a delay amount of a signal transmitted from the plurality of non-volatile memory devices to the controller, and
the controller broadcasts the read command during a process to determine the delay amount.

10. The storage device according to claim 1, wherein
chip enable signal lines are connected in parallel between the controller and the plurality of non-volatile memory devices, respectively, and
the controller is configured to assert a chip enable signal in each of the chip enable signal lines during the certain period of time to enable the plurality of non-volatile memory devices.

10. The storage device according to claim 9, wherein
the chip enable signal includes a certain number of bits equal to the number of the plurality of non-volatile memory devices, and each of the bits corresponds to one of the plurality of non-volatile memory devices.

11. A storage device comprising:
a plurality of non-volatile memory devices; and
a controller connected to the plurality of non-volatile memory devices and configured to enable the plurality of non-volatile memory devices simultaneously during a certain period of time, and broadcast a read command and a read destination address to the plurality of non-volatile memory devices during the certain period of time.

12. The storage device according to claim 11, wherein the controller is further configured to:
enable only a first one of the plurality of non-volatile memory devices during a second certain period of time after the certain period of time and receive read data corresponding to the read command from the first one of the plurality of non-volatile memory devices during the second certain period of time; and
enable only a second one of the plurality of non-volatile memory devices during a third certain period of time after the second certain period of time and receive read data corresponding to the read command from the second one of the plurality of non-volatile memory devices during the third certain period of time.

13. The storage device according to claim 11, wherein
a first one of the plurality of non-volatile memory devices is configured to transmit read data corresponding to the read command to the controller a first predetermined period of time after receiving the read command, and
a second one of the plurality of non-volatile memory devices is configured to transmit read data corresponding to the read command to the controller a second predetermined period of time after receiving the read command, the second predetermined period of time being different from the first predetermined period of time.

14. The storage device according to claim 13, wherein
a time period during which the read data from the first one of the plurality of non-volatile memory devices is transmitted to the controller has no overlap with a time period during which the read data from the second one of the plurality of non-volatile memory devices is transmitted to the controller.

15. The storage device according to claim 11, wherein
the controller includes a delay adjustment circuit configured to adjust a delay amount of a signal transmitted from the plurality of non-volatile memory devices to the controller, and
the controller broadcasts the read command during a process to determine the delay amount.

16. A method of controlling a plurality of non-volatile memory devices, comprising:
enabling the plurality of non-volatile memory devices simultaneously during a certain period of time; and
broadcasting an access command and an access destination address to the plurality of non-volatile memory devices during the certain period of time.

17. The method of claim 16, wherein the access command includes a write command, and the access destination address includes a write destination address.

18. The method of claim 17, further comprising:
broadcasting write data corresponding to the write command to the plurality of non-volatile memory devices during the certain period of time, after broadcasting the write command and the write destination address.

19. The method of claim 16, wherein the access command includes a read command, and the access destination address includes a read destination address.

20. The method of claim 19, further comprising:
enabling only a first one of the plurality of non-volatile memory devices during a second certain period of time after the certain period of time and receiving read data corresponding to the read command from the first one of the plurality of non-volatile memory devices during the second certain period of time; and
enabling only a second one of the plurality of non-volatile memory devices during a third certain period of time after the second certain period of time and receiving read data corresponding to the read command from the second one of the plurality of non-volatile memory devices during the third certain period of time.
